(19) United States
(12) Patent Application Publication
(10) Pub. No.: US 2009/0103828 A1
(43) Pub. Date: Apr. 23, 2009

(54) Image Processing Apparatus, Image Processing Method, and Computer-Readable Recording Medium Having Image Processing Program

(75) Inventors: Tomoki Shibukawa, Kanagawa (JP); Aritaka Hagiwara, Kanagawa (JP); Takahiko Hayashi, Tokyo (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/247,329

(22) Filed: Oct. 8, 2008

(30) Foreign Application Priority Data
Oct. 17, 2007 (JP) 2007-270021

(51) Int. Cl. G06K 9/40

(52) U.S. Cl. 382/260

(57) ABSTRACT

An image processing apparatus includes an input filter configured to control an input process of image data input as an object being processed; output filters configured to control output processes of output image data being output to an outside of the apparatus; at least one process filter configured to process the image data between the input filter and the output filter; and an operation unit configured to manage process operation of the image processing apparatus; wherein when the plural output filters are selected by the operation unit for the input filter selected by the operation unit, the at least one process filter is connected to each of the selected output filters.

### BACKGROUND OF THE INVENTION

1. Field of the Invention

This invention relates to an image processing apparatus, an image processing method, and a computer readable recording medium having an image processing program.

2. Description of the Related Art

In recent years, there are image forming apparatuses such as multi-function apparatuses or the like which achieve functions of a printer, a copier, a scanner, and a facsimile. The multi-function apparatuses include conventional computers as well as CPUs (central processing units). Each function of the multi-function apparatus or the like is provided by controlling applications.

For example, in an image forming apparatus described in the patent document 1 (Japanese Patent No. 3679349), the image forming apparatus includes functions commonly used by each application platform, and by using an application program interface (API) of the platform, the applications can be implemented in the image forming apparatus. Such an image forming apparatus can improve the efficiency of developing total applications because commonly used functions are provided in the image forming apparatus via the platform, so that installation of duplicate functions can be avoided.

However, in general, a platform including a commonly used API tends to have problems and therefore does not improve the efficiency of the application development when functions or each interface grain size provided by the platform is not properly designed.

For example, when each grain size is too small, the source code of an application becomes complicated because a large number of APIs need to be requested to process the application even though the application only provides a simple service.

On the other hand, when each grain size is too big, development man-hours can be increased to install an application whose part of the function is modified because the platform needs to be modified within the platform itself. Particularly, when each module in the platform depends on other modules, not only additional new functions but also modifying existing parts in the platform are required. This would make everything complicated.

Also, an application cannot be generated by modifying part (for example, input process of an image) of a service of the existing application. In this case, new source code needs to be written to generate new applications for mounting.

The present invention is carried out by considering the above problems, and this invention provides an image processing apparatus, an image processing method, and a computer readable recording medium having an image processing program, which are capable of customizing functions and simplifying expandability of the functions.

### SUMMARY OF THE INVENTION

According to one aspect of the present invention, an image processing apparatus includes an input filter configured to control an input process of image data input as an object being processed; output filters configured to control output processes of output image data being output to an outside of the apparatus; at least one process filter configured to process the image data between the input filter and the output filter; and an operation unit configured to manage process operation of the image processing apparatus; wherein when the plural output filters are selected by the operation unit for the input filter selected by the operation unit, the at least one process filter is connected to each of the selected output filters.

According to this invention, customization and extension of functions can be simplified.

Other objects, features and advantages of the present invention will become more apparent from the following detailed description when read in conjunction with the accompanying drawings.

### BRIEF DESCRIPTION OF THE DRAWINGS

FIG. 1 is a drawing for describing a concept of a pipe and a filter;

FIG. 2 is a drawing showing a hardware construction of an image processing apparatus for which the concept of a pipe and filter is applied;

FIG. 3 is a drawing showing a software architecture of an image processing apparatus 100 of the first embodiment of the invention;

FIG. 4 is a drawing describing a print process of the image processing apparatus 100 of the first embodiment;

FIG. 5 is a drawing describing an example for an input filter and an output filter;

FIG. 6 is a drawing showing a software architecture of an image processing apparatus 100A of the second embodiment;

FIG. 7 is a drawing for explaining a architecture of a filter and an activity included in the image processing apparatus 100A of the second embodiment;

FIG. 8 is a drawing for explaining the multiple outputs of the image processing apparatus 100A of the second embodiment;

FIG. 9 shows the first sequence diagram for explaining operations of the image processing apparatus 100A of the second embodiment;

FIG. 10 shows the second sequence diagram for explaining operations of the image processing apparatus 100A of the second embodiment;

FIG. 11 is a drawing showing the first example of a setting screen on the image processing apparatus 100A of the second embodiment;

FIG. 12 is a drawing showing the second example of a setting screen on the image processing apparatus 100A of the second embodiment;

FIG. 13 is a drawing showing the third example of a setting screen on the image processing apparatus 100A of the second embodiment;

FIG. 14 is a drawing showing the fourth example of a setting screen on the image processing apparatus 100A of the second embodiment;

FIG. 15 is a drawing showing a block diagram of a concept of filters when plural output filters 133 are connected to one process filter 132;

FIG. 16 is a sequence diagram explaining operations of the plural filters connected to one process filter in the image processing apparatus 100A of the second embodiment;

FIG. 17 is a drawing showing a block diagram of a concept of filters in which an output filter 133 is directly connected to an input filter 131;

FIG. 18 is a sequence diagram explaining operations in which a document registration filter 133b is connected to a read filter 131a;

FIG. 19 is a drawing showing a block diagram of a concept of filters in case where a common process filter 135 is connected between an input filter 131 and a process filter 132;

FIG. 20 is a sequence diagram explaining the operation in which a common process filter 135 is connected between an input filter 131 and a process filter 132;

FIG. 21 is a drawing showing the fifth example of a setting screen on the image processing apparatus 100A of the second embodiment; and

FIG. 22 is a flowchart for explaining how a filter architecture is determined with the image processing apparatus 100A of the second embodiment.

### DETAILED DESCRIPTION OF THE PREFERRED EMBODIMENTS

One embodiment of this invention may apply software architecture, based on a concept of the pipe and filter, to an image processing apparatus, to thereby simplify the customization and extension of functions. Further; low productivity can be avoided by efficiently using small capacity semiconductor memories.

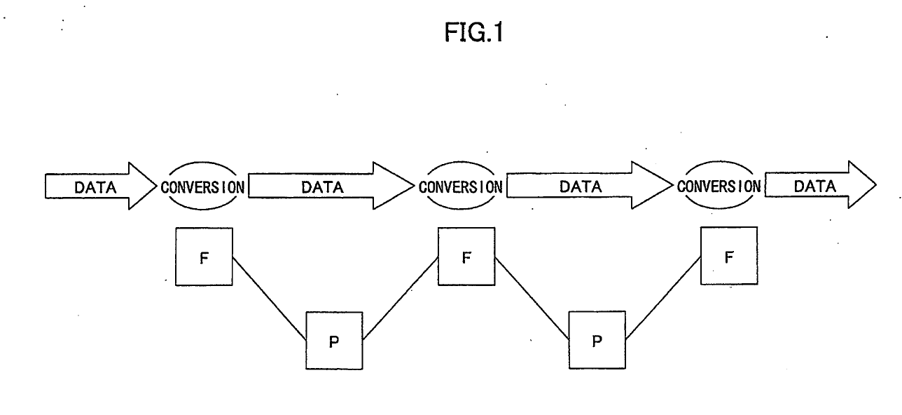

In the following, a concept of pipe-and-filter used in an image processing apparatus of this invention is described before explaining an embodiment of the invention. FIG. 1 is a drawing explaining the concept of pipe-and-filter. In FIG. 1, “P” indicates a pipe, and “F” indicates a filter.

A filter is a program that performs a predetermined process for input image data and outputs the process result. A pipe is a unit that connects a filter to another filter. A pipe temporarily retains a process result output from the filter connected to the input side of the pipe, and then transmits image data to another filter connected to the output side of the pipe afterwards. In this manner, based on the concept of pipe-and-filter, the processes performed by filters can be a continuous process by using pipes between filters.

For this invention, a predetermined process performed by a filter is regarded as a predetermined converting process performed for input image data. Thus, for an image processing apparatus of the invention, corresponding functions performed by the image processing apparatus are regarded as a series of “conversion processes” for a document (input image data). The corresponding functions of the image forming apparatus are achieved by input, process and output of a document, i.e., input of image data. In the following description of embodiments, “input”, “processing”, and “output” are respectively regarded as a “conversion process”, and a software part performing a single conversion process constitutes a filter.

For this invention, an input filter controls the input process of image data, a process filter manages the data processing of image data, and an output filter controls the output process of image data. Each filter is an independent program. There are no dependent relationships between the filters. Thus, for each filter, addition (installation) and deletion (uninstallation) can be performed separately in the image processing apparatus.

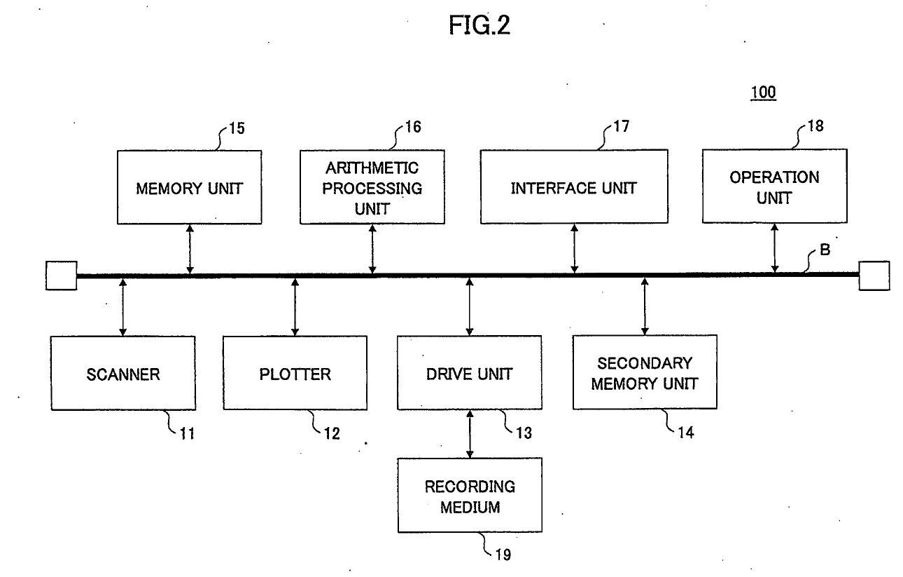

FIG. 2 is a hardware architecture drawing of an example of an image processing apparatus to which a general concept of pipe-and-filter is applied. The image processing apparatus 100 includes a scanner 11, a plotter 12, a drive unit 13, a secondary memory 14, a memory unit 15, an arithmetic processing unit 16, an interface unit 17, and an operation unit 18. Each unit is connected to each other via bus B.

The scanner 11 includes a scanner engine or the like, which is used to form image data by reading a document. The plotter 12 includes a plotter engine or the like, which is used to print image data. The interface unit 17 includes a modem, a local area network card and the like, which is used to connect with a network 200, as described later.

An image processing program of this invention is at least one part of various programs which control the image processing apparatus 100. The image processing program is provided by, for example, distribution of a recording medium 19, a download from the network 200 or the like. The recording medium 19 of an image processing program may be a CD-ROM; a flexible disk; a recording medium which electrically, optically or magnetically records information on a MO disk or the like; a ROM; a flash memory which is a semiconductor memory or the like recording information electronically; or other various types of recording media or the like.

Also, when the recording medium 19 including an image processing program is set in the drive unit 13, the image processing program is installed in the secondary memory unit 14 from the recording medium 19 via drive unit 13. The image processing program downloaded from the network 200 is installed in the secondary memory unit 14 through the interface unit 17.

The image processing apparatus 100 stores the installed image processing program, a necessary file, image data or the like. The memory unit 15 reads the image processing program from the secondary memory unit 14 and stores the program when starting a computer. Thus, the arithmetic processing unit 16 performs various processes, as described later, according to the image processing program stored in the memory unit 15.

### The First Embodiment

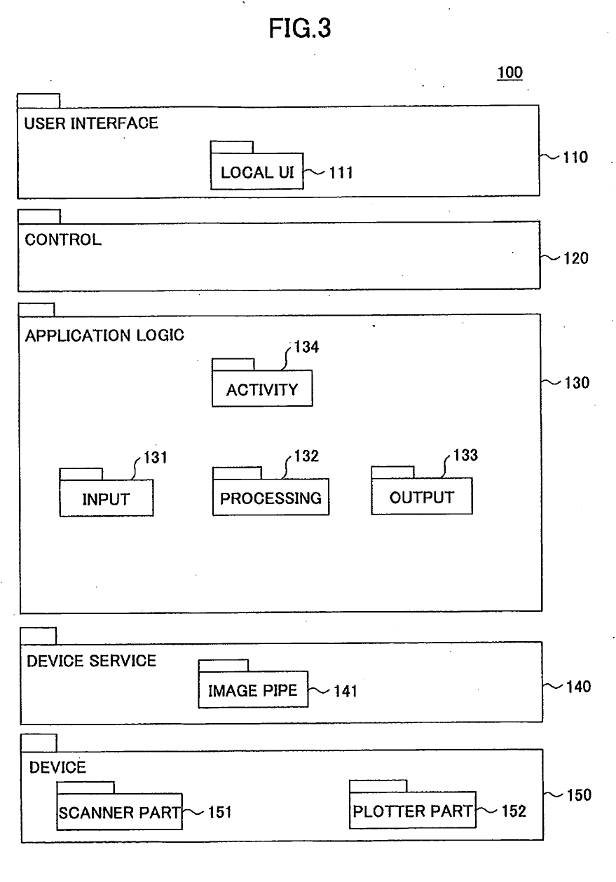

FIG. 3 is a drawing showing software architecture of the image processing apparatus 100 of the first embodiment of this invention. The image processing apparatus 100 is a multi-function apparatus performing plural functions such as functions of a printer, a copier, a scanner or a fax.

The software to perform a function of the image processing apparatus 100 is provided by a hierarchical structure. The hierarchical structure is constituted by a user interface layer 110, a control layer 120, an application logic layer 130, a device service layer 140 and a device layer 150. The top and bottom relationship for each layer is based on a calling relationship between the layers. In short, a higher level layer calls a lower level layer.

In the image processing apparatus 100, the user interface layer 110 calls the control layer 120 after the execution instruction of various functions of a user have been made by the user interface layer 110, and controls the application logic layer 130 based on the execution instruction. In the application logic layer 130, based on the instruction from the control layer 120, an application to perform a demanded function is executed. Further, based on the execution result, the device service layer 140 and the device layer 150 control hardware resources of the image processing apparatus 100. In the image processing apparatus 100, an output result corresponding to the function received by the user interface layer 110 is provided through these operations.

The following descriptions are with regard to respective layers.

In the user interface layer 110, for example, a local UI (user interface) part 111 is implemented and has a function to accept an execution instruction to achieve various functions of the image processing apparatus 100. Here, various functions are, for example, a copy function, a print function, a scanner function, a FAX function and the like. For example, the local UI part 111 may be provided in the operation unit 18 of the image processing apparatus 100. For example, the operation unit 18 may be controlled by operation panels of a display region. In the user interface layer 110, the execution instruction received by the local UI part 111 is transmitted to the control layer 120.

In the control layer 120, a function to control processing that performs each function of the image processing apparatus 100 is implemented. Specifically, the control layer 120 controls execution of each filter in the application logic layer 130 in response to a requested function. For the image processing apparatus 100, as described in the following embodiments, a function is a definition of unit service including a certain amount of unit service provided by the image processing apparatus 100 for a user. The function has the same meaning as an application providing a certain amount of unit service.

In the application logic layer 130, various filters, parts which achieve part of a function provided in the image processing apparatus 100, are implemented. In the application logic layer 130, the control layer 120 combines plural filters to perform a single function. In the application logic layer 130 of this embodiment, the input filter 131, the processing filter 132, the output filter 133 and the activity 134 are implemented. Each filter implemented by the application logic layer 130 operates based on a specification determined by each filter and is controlled based on the specification. The details of each filter are described later. The activity 134 connects each filter according to a function requested in the user interface layer 110. The activity 134 is a component combining execution of each filter.

In the device service layer 140, a lower function commonly used by each filter in the application logic layer 130 is implemented. The image pipe 141 is implemented in the device service layer 140 of this embodiment. The image pipe 141 performs a function of the pipe as described above, and transmits an output result from one filter among each of the filters implemented by the application logic layer 130 to another filter. Here, for example, the image pipe 141 may connect the input filter 131 and the processing filter 132 or may connect the processing filter 132 and the output filter 133.

A driver, which is a program for controlling hardware, is implemented in the device layer 150. In the device layer 150 of this embodiment, for example, a scanner part 151, a plotter part 152 and the like are implemented. Each control unit controls, correspondingly, the device indicated by each name.

In the following, each filter implemented in the application logic layer 130 is described.

The input filter 131 of this embodiment controls input processing for image data input external from the image processing apparatus 100. For example, the input filter 131 includes a reading filter, an E-mail reception filter, a FAX reception filter, and a PC document reception filter (not shown). The reading filter controls reading of image data with a scanner or the like, and outputs the read image data. The E-mail reception filter receives an E-mail in the image processing apparatus 100 and outputs the image data included in the received E-mail. The FAX reception filter controls the FAX reception and outputs the received image data. The PC document reception filter receives print image data sent by a client PC or the like (not shown) and outputs that print image data. The report filter (not shown) arranges setting information and operation history information or the like of the image processing apparatus 100 into a list or the like, for example, and outputs the arranged image data.

The processing filter 132 of this embodiment performs predetermined processing for image data input by a filter on the input side of the processing filter 132. The processing filter 132 of this embodiment outputs a processing result to a filter on the output side of the processing filter 132. For example, here, the processing includes the collection, expansion, reduction, and rotation of input image.

The output filter 133 of this embodiment manages the output processed for input image data and outputs the output data externally from the image processing apparatus 100. The output filter 133 includes a print filter, a preview filter, an E-mail transmission filter, a FAX transmission filter, a PC document transmission filter, a document registration filter (or the like).

The print filter causes the plotter part 152 to output (print) the input image data. The preview filter causes the operation unit 18 of the image processing apparatus 100 or the like to display a preview of the input image-data. Also, the E-mail transmission filter attaches image data with an E-mail and transmits the E-mail. The FAX transmission filter transmits input image data via a fax. The PC document transmission filter transmits input image data to a client PC (not shown) or the like. The document registration filter outputs and stores the input image data into the secondary memory unit 14 or the like.

An instruction input into the local UI part 111 at the user interface layer 110 is transmitted to the activity 134 of this embodiment via the control layer 120. According to this instruction, the activity 134 manages the execution of a job for the input filter 131, the processing filter 132, and the output filter 133.

In the application logic layer 130, each function of the image processing apparatus 100 is performed by combining the above filters. According to the architecture of this embodiment, the image processing apparatus 100 can perform various functions by combining filters and pipes. Specifically, for example, when one wants to perform a copy function, a reading filter included in the input filter 131, the processing filter 132, and a print filter included in the output filter 133 may be combined together.

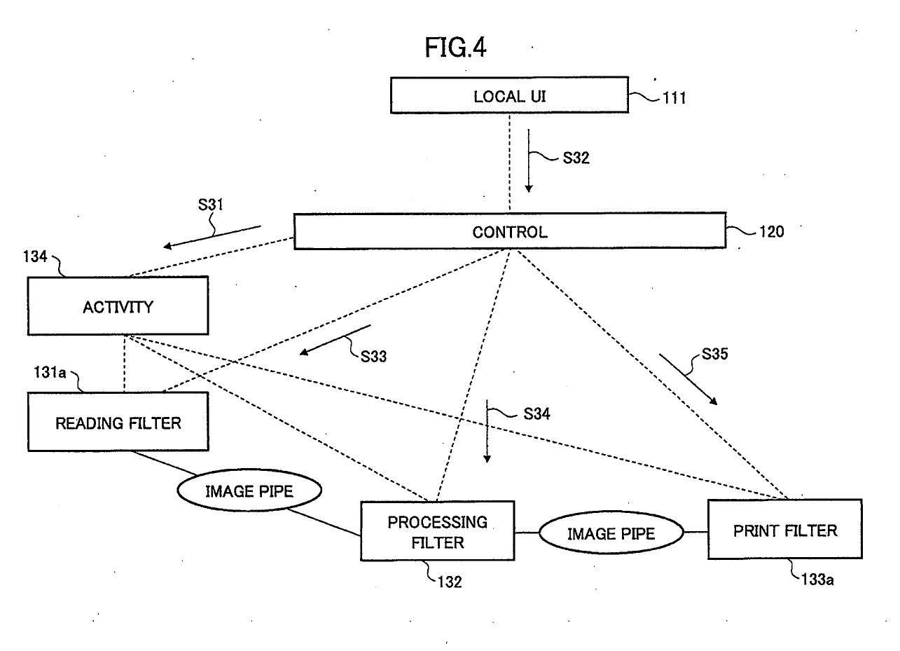

In the following, a print processing in the image processing apparatus 100 of this embodiment is explained. FIG. 4 is a drawing describing the print processing in the image processing apparatus 100 of the first embodiment.

In the image processing apparatus 100 of this embodiment, the control layer 120 generates a job (S31) for the activity 134 to manage execution of a process at each filter. For the image processing apparatus 100 of this embodiment, for example, a job may be generated for the activity 134 when a power supply of the image processing apparatus 100 is turned on.

When an execution of print processing is requested by the local UI part 111, the local UI part 111 transmits the request to the control layer 120 (S32). Further, in an example of FIG. 4, it is assumed that a copy process is chosen as one of the print processing operations. In this case, in the local UI part 111, operations to instruct reading of a paper document and printing are performed.

When receiving instruction of reading and printing of a paper document, the activity 134 connects a reading filter 131a, the processing filter 132, and a print filter 133a via image pipes. In this case, a reading filter included in the reading filter 131a is connected to the processing filter 132. Next, the control layer 120 generates a job (S33) executed by the reading filter 131a, a job (S34) executed by the processing filter 132, and a job (S35) executed by the print filter 133a.

When a job to be executed with each filter is generated by the control layer 120, the activity 134 instructs an execution of the job for each filter. Then, as an input part, the scanner part 151, executes a process to read a paper document, and the paper document is read as image data by the reading filter 131a. This image data is output by the reading filter 131a, and transmitted to the processing filter 132 via the image pipe 141 (FIG. 3).

In the processing filter 132, a predetermined processing is performed for this image data and outputs as processed image data. Next, the processed image data is transmitted to the print filter 133a, which is one of output filters 133. In the print filter 133a, the processed image data is output from the plotter part 152, which is the output part, to perform copy processing.

In this manner, for this embodiment, the input filter 131, the processing filter 132, and the output filter 133 are each separately controlled, and thus there is no dependent relationship between filters. Based on this reason, for this embodiment, when a function is customized or expanded, the customization may be performed for corresponding filters. According to this embodiment, a customization or expansion of a function can be simplified.

### Second Embodiment

In the following, the second embodiment of this invention is described by referring to drawings. The second embodiment of this invention is further improved from the first embodiment, and performs multiple image data outputs to be described below. In an explanation of the following second embodiment, for a part having a similar functional architecture that is used in the first embodiment, the same reference symbols are used as in the first embodiment for the explanation, and the explanation for the part is omitted.

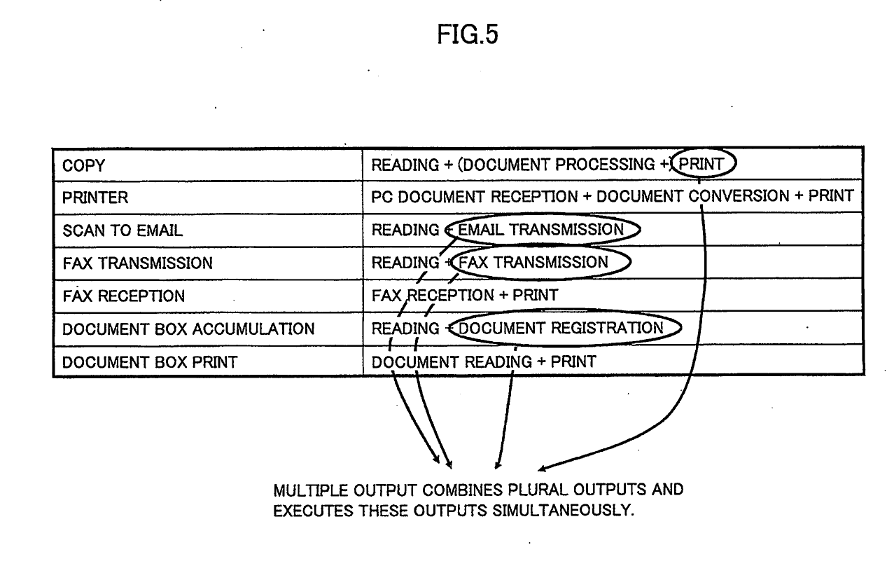

Referring to FIG. 5, the embodiment relating to multiple outputs is explained. FIG. 5 is a drawing describing an example of a combination between input filters and output filters. In the example shown in FIG. 5, data read by the reading filter 131a included in the input filter 131 is output as four types of output data by using four output filters, namely, the print filter, the document registration filter, the E-mail transmission filter and the FAX transmission filter, all of which are included in the output filter 133.

In this manner, the data input by one input filter 131 is output through plural output filters 133, and is referred to as multiple outputs. The multiple outputs of image data can be easily achieved with an image processing apparatus which applies a concept of pipe-and-filter, similar to the image processing apparatus of this invention. In recent years, for the multiple outputs of image data, an image processing apparatus has been desired in which processing requirement or the like of image data can be set independently for each output path.

In addition to the production of multiple outputs, an image processing apparatus of this embodiment makes it possible for performing the setting of image data independently for respective outputs of the multiple outputs. The image processing apparatus of this embodiment is described in the following.

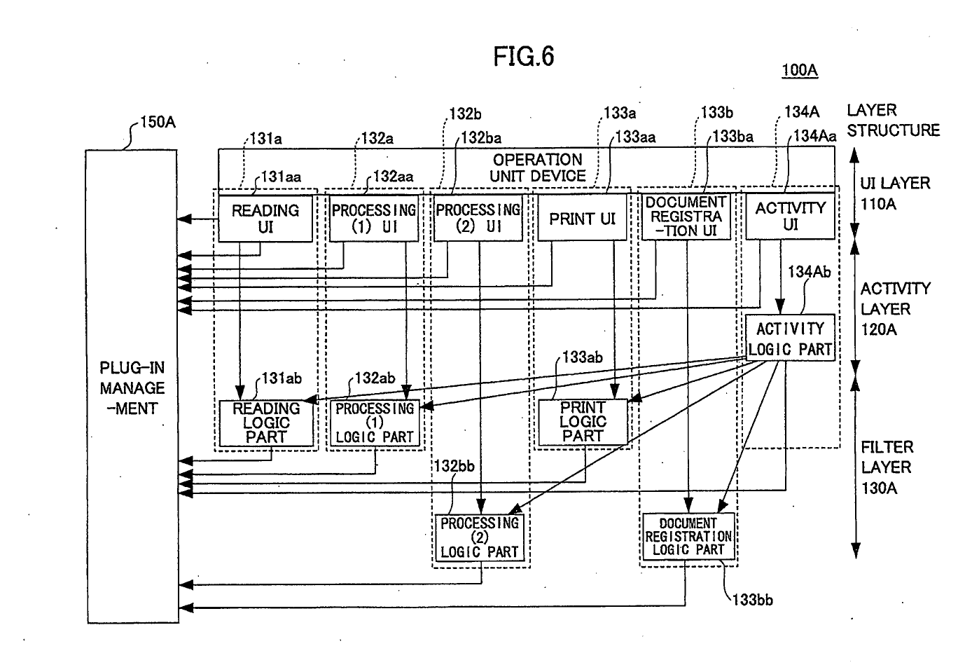

FIG. 6 is a drawing showing a software architecture of the image processing apparatus 100A of the second embodiment.

The software performing the functions of the image processing apparatus 100A has a hierarchy structure and includes the user interface layer (in the following, UI layer) 110A, the activity layer 120A, and the filter layer 130A. Also, the image processing apparatus 100A of this embodiment includes a plug-in management 150A having a function being common to each layer. A top-and-bottom relationship of each of these layers is based on a calling relationship between the layers. Namely, in FIG. 6, a higher layer calls a lower layer.

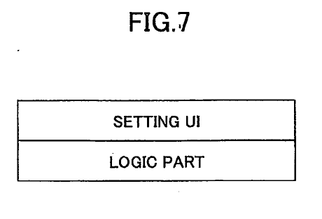

Preceding an explanation of each layer, architecture of each filter included in the image processing apparatus 100A of this embodiment is explained by referring to a FIG. 7.

FIG. 7 is a drawing describing architecture of the filter and activity included in the image processing apparatus 100A of the second embodiment. The image processing apparatus 100A of this embodiment includes an input filter, a processing filter, an output filter, and an activity. As shown in FIG. 7, the filter and the activity of this embodiment consist of a logic region managing execution of a job and a control UI performing various settings.

Referring to FIG. 6, each layer of the image processing apparatus 100A of this embodiment is described.

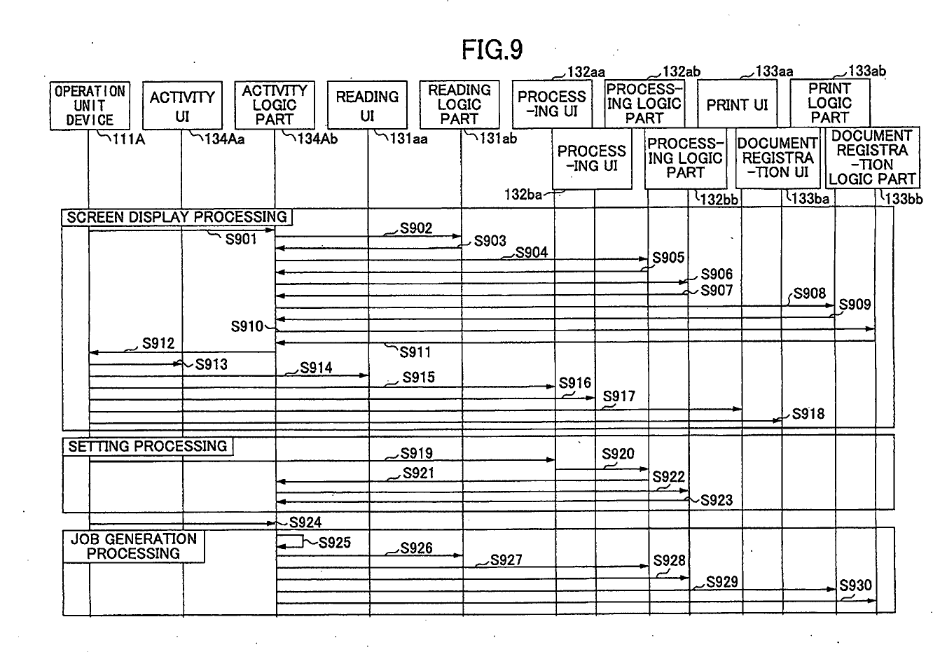

The UI layer 110A of this embodiment includes an operation unit device 111A and the setting UIs for setting each filter and the activity. The operation unit device 111A (in FIG. 9) controls the operation unit 18 (in FIG. 2), and each setting UI establishes setting of each filter.

In an example, FIG. 6 shows a reading filter 131a included in the input filter 131; a processing filter 132a, a processing filter 132b, and a print filter 133a included in the output filter 133, and a document registration filter 133b. Thus, the UI layer 110A includes a reading UI 131aa which is a setting UI of the reading filter 131a; the processing filter 132a; the processing UI 132aa which is a setting UI of the processing filter 132b; the processing UI 132ba; the print UI 133aa which is a setting UI of the print filter 133a; and the document registration UI 133ba which is a setting UI of the document registration filter 133b. Also, the UT layer 110A includes the activity 134Aa which is a setting UI of the activity UI 134Aa.

In activity layer 120A of this embodiment, an activity logic part 134Ab, which is a logic part of the activity 134A, is arranged. The activity logic part 134Ab of this embodiment controls operation of the logic region of each filter located in the lower level of the filter layer 130A of the activity layer 120A.

The filter layer 130A of this embodiment includes each filter of the logic parts. A logic part of each filter includes a reading logic part 131ab which is a logic part of the reading filter 131a; a processing filter 132a which is a logic part of the processing filter 132b; a processing logic part 132ab; a processing logic region 132bb; a print logic region 133ab which is a logic part of a print filter 133a; and a document registration logic region 133bb which is a logic part of a document registration filter 133b.

The plug-in management 150A manages a plug-in (a filter) to the image processing apparatus 100A. For example, the plug-in management 150A manages uninstallation and installation of a filter of the image processing apparatus 100A.

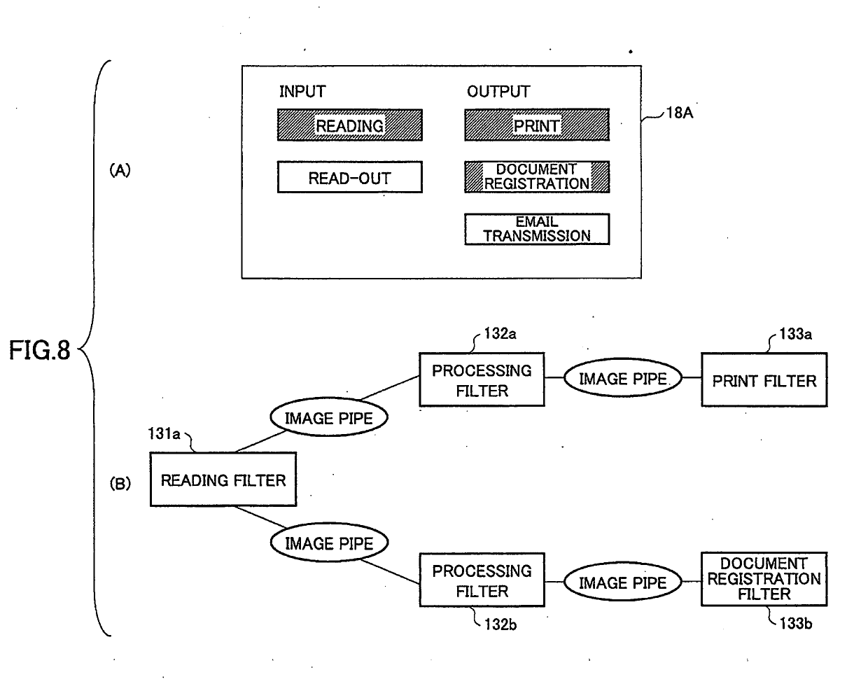

Next, FIG. 8 illustrates multiple outputs of the image processing apparatus 100A of this embodiment. FIG. 8 is a drawing describing the multiple outputs of the image processing apparatus 100A of the second embodiment.

For the image processing apparatus 100A of this embodiment, the multiple outputs of image data is achieved by selecting plural output functions using an operation screen 18A displayed by the operation unit 18.

FIG. 8(A) is a drawing showing an example of the operation screen displayed with the operation unit 18. An input function and an output function can be selected by using the operation screen 18A indicated in FIG. 8(A). In the operation screen 18A, for example, reading of image data by a scanner 11 is selected as an input function, and two functions are selected as output functions which are printing of the scanned image data using the plotter 12 and document registration for accumulating the scanned image data. As a result, in this case, the reading filter 131a is selected as the input filter 131, and the print filter 133a and the document registration filter 133b are chosen as the output filter 133.

In this embodiment, when plural output filters are chosen for a single input filter, each filter is connected to each other as shown in FIG. 8(B). This connection makes it possible to achieve the multiple outputs of image data. FIG. 8(B) is a drawing showing the connection of filters for the multiple outputs. In this embodiment, when plural output filters are selected, processing filters are connected between respective selected output filters and the input filter. In FIG. 8(B), a processing filter 132a is connected between the reading filter 131a and the print filter 133a, and the processing filter 132b is connected between the reading filter 131a and the document registration filter 133b. The image data having been read by the reading filter 131a is read by the processing filters 132a, 132b correspondingly, and transmitted to the print filter 133a and the document registration filter 133b.

In this embodiment, the multiple outputs of image data are performed. Also, in this embodiment, when multiple outputs are performed, a process can be set for each processing filter 132 depending on each output filter 133.

In the following, the operation of the image processing apparatus 100A of this embodiment is described by referring to FIG. 9. FIG. 9 is the first sequence diagram explaining the operation of the image processing apparatus 100A of the second embodiment.

First, for the image processing apparatus 10A, the operation in which a setting screen is displayed on the operation unit 18 for setting each output is described.

In the image processing apparatus 100A, when instruction is made for displaying a setting screen on the operation unit 18, the operation unit device 111A directs the activity logic part 134Ab to generate a screen (S901). The activity logic part 134Ab establishes an initial setting (S902) of the reading filter 131a for the reading logic part 131ab after receiving the screen generation instruction. The reading logic part 131ab notifies the activity logic part 134Ab that the initial setting has been made (S903).

In the same manner, the activity logic part 134Ab establishes a default setting for a logic part of each filter. In short, the activity logic part 134Ab establishes the default setting of the processing filter 132a for the processing logic part 132ab (S904). The processing logic part 132ab notifies the activity logic part 134Ab that the default setting has been selected (S905). The activity logic part 134Ab establishes a default setting of the processing filter 132b for the processing logic part 132bb (S906). The processing logic part 132bb notifies the activity logic part 134Ab that the default setting has been made (S907).

Further, the activity logic part 134Ab establishes a default setting of the print filter 133a for the print logic part 133ab (S908). The print logic part 133ab notifies the activity logic part 134Ab that the default setting has been made (S909). The activity logic part 134Ab establishes a default setting of the document registration filter 133b for the document registration logic part 133bb (S910). The document registration logic part 133bb notifies the activity logic part 134Ab that the default setting has been made (S911).

When the default setting is made for each filter, the activity logic part 134Ab notifies the operation unit device 111A that the default setting has been made(S912). After receiving this notice, the operation unit device 111A instructs the activity UI 134Aa (S913) to display a screen. Also, the operation unit device 111A instructs a setting UI of each filter to display a screen. The operation unit device 111A instructs the reading UI 131aa to display a screen (S914). Likewise, the operation unit device 111A instructs the processing UI 132aa and the processing UI 132ba to display a screen (S915, S916). Also, the operation unit device 111A instructs the print UI 133aa and the document registration UI 133ba to display a screen (S917, S918).

Likewise, for the image processing apparatus 10A, the operation unit 18 displays a default setting screen for each output.

Next, setting of processing of the image processing apparatus 100A of this embodiment is described for each output. For an example shown in FIG. 9, it is assumed that the setting of processing established by the processing filter 132a is reflected in the processing filter 132b as well.

After instruction of the setting of processing is made for the processing filter 132a with the operation unit 18 in the image processing apparatus 100A, the operation unit device 111A transmits the instruction to the processing UI 132aa (S919). Here, it is assumed that an arrangement of executing a function A is established for the processing filter 132a. The processing UI 132aa establishes the condition to execute the function A according to the instruction for the processing logic part 132ab (S920). The processing logic part 132ab notifies the activity logic part 134Ab that the condition of the function A has been established (S921).

After receiving the notice, the activity logic part 134Ab establishes the arrangement of the processing logic part 132bb (S922) to perform the function A. The processing logic part 132bb notifies the activity logic part 134Ab that the setting has been changed (S923).

Next, a generation of a job in the image processing apparatus 100A of this embodiment is described. For the image processing apparatus 100A of this embodiment, when an execution instruction of processing is made, each job to be executed by each filter is generated based on the instructed processing content.

In the image processing apparatus 10A, the activity logic part 134Ab determines whether to generate a job depending on the processing content after the execution instruction of processing has been made (S924) (S925). Next, the activity logic part 134Ab generates a job to be executed by a logic part of each filter.

The activity logic part 134Ab generates a job of the reading logic part 131ab (S926). The activity logic part 134Ab generates jobs of the processing logic part 132ab and the processing logic part 132bb (S927, S928). Also, the activity logic part 134Ab generates jobs of the print logic part 133ab and the document registration logic part 133bb (S929, S930).

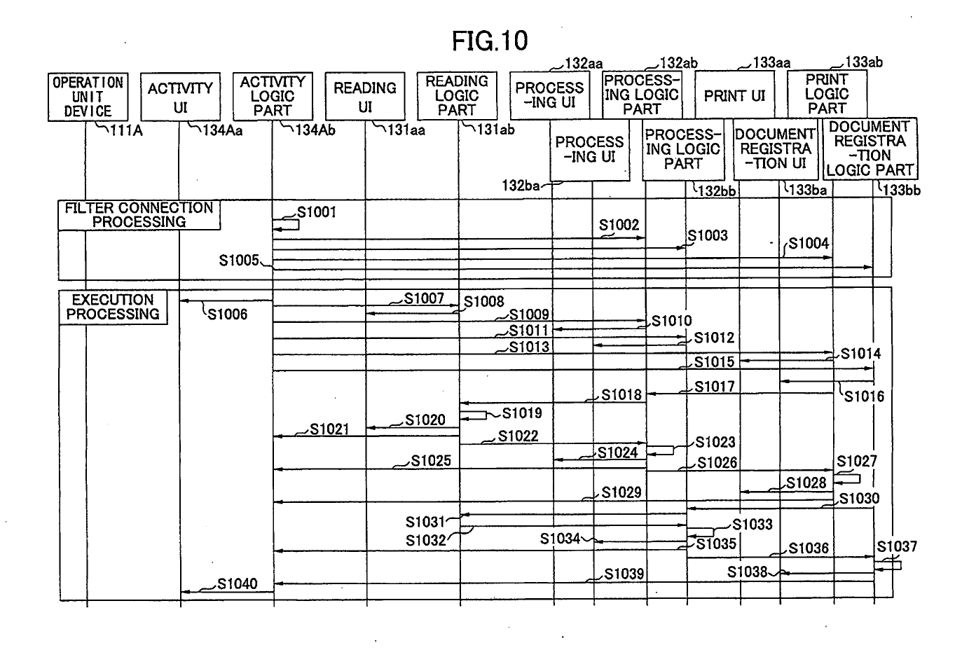

Next, with reference to FIG. 10, operation of the image processing apparatus 100A of this embodiment is explained. FIG. 10 shows the second sequence diagram describing operation of the image processing apparatus 100A of the second embodiment.

First, connection of each filter in the image processing apparatus 100A is explained. The activity logic part 134Ab generates associations between each filter based on the relationship between jobs of the generated filters in the image processing apparatus 100A of the embodiment (S1001). Also, the activity logic part 134Ab connects between the processing logic part 132ab, the processing logic part 132bb and the reading filter 131a (S1002, S1003).

Next, the activity logic part 134Ab connects the processing logic part 132ab with the print logic part 133ab (S1004). Also, the activity logic part 134Ab connects the processing logic part 132bb with the document registration logic part 133bb (S1005).

In this present embodiment, each filter is connected in the manner as described above.

Next, execution of jobs is explained for the case of the image processing apparatus 100A of this embodiment. When the execution instruction of processing is made in the image processing apparatus 100A of this embodiment, the activity logic part 134Ab directs each filter to execute the job.

At first, the activity logic part 134Ab notifies the activity UI 134Aa that each filter has been connected (S1006). Further, the activity logic part 134Ab instructs the reading logic part 131ab (S1007) to execute the job. The reading logic part 131ab executes the job and notifies the reading UI 131Aa about the progress of the processing (S1008).

At first, the activity logic part 134Ab notifies the activity UI 134Aa that each filter has been connected (S1006). Further, the activity logic part 134Ab instructs the reading logic part 131ab (S1007) to execute a job. The reading logic part 131ab executes the job and notifies the reading UI 131Aa of the progress of processing (S1008).

First, the activity logic part 134Ab notifies the activity UI 134Aa that each filter has been connected (S1006). Further, the activity logic part 134Ab instructs the reading logic part 131ab (S1007) to execute a job. The reading logic part 131ab executes the job and notifies the reading UI 131Aa of the progress of processing (S1008).

Next, the activity logic part 134Ab instructs the processing logic part 132ab (S1009) to execute a job. The processing logic part 132ab executes the job according to the instruction and notifies the processing UI 132aa of the progress of the processing (S1010). Further, the activity logic part 134Ab instructs the processing logic part 132bb (S1011) to execute a job. The processing logic part 132bb executes the job and notifies the processing UI 132ba of the progress of processing (S1012).

The activity logic part 134Ab instructs the print logic part 133ab (S1013) to execute a job. The print logic part 133ab executes the job according to the instruction and notifies the print UI 133aa of the progress of the processing (S1014). Also, the activity logic part 134Ab instructs the document registration logic part 132bb (S1015) to execute a job. The document registration logic part 133bb executes the job and notifies the document registration UI 133ba of the progress of the processing (S1016).

After instructing all filters to execute jobs, the print logic part 133ab requests image data from the processing logic region 132ab (S1017). The processing logic part 132ab requests image data from the reading logic part 131ab according to the request (S1018). The reading logic part 131ab executes reading of image data according to this request (S1019)

After reading the image data, the reading logic part 131ab notifies the reading UI 131aa and the activity logic part 134Ab of progress of the processing (S1020, S1021). The reading logic part 131ab outputs the image data to the processing logic part 132ab (S1022).

After receiving the image data, the processing logic part 132ab performs image processing on the image data (S1023). In this case, this image processing is made based on a processing condition established in the processing filter 132a. Here, the processing condition established by the processing filter 132a is a processing condition to execute a function A (FIG. 9, S920), and the processing logic part 132ab executes image processing based on this processing condition.

Next, the processing logic part 132ab notifies the processing UI 132aa and the activity logic part 134Ab of progress of the processing (S1024, S1025). The processing logic part 132ab outputs the image data in which image processing is completed to the print logic part 133ab (S1026).

After receiving the image data, the print logic part 133ab executes print processing of the image data (S1027). The print logic part 133ab notifies the print UI 133aa and the activity logic part 134Ab of progress of the processing (S1028, S1029).

Next, the document registration logic part 133bb requests image data from the processing logic part 132bb (S1030). After receiving the request of image data, the processing logic part 132bb requests image data from the reading logic part 131ab (S1031). Next, image data are read in S1019 and the reading logic part 131ab outputs the image data to the processing logic part 132bb (S1032).

After receiving the image data, the processing logic part 132bb performs image processing of image data (S1033). Also, the image processing is performed based on a processing condition set in the processing filter 132b. Here, the processing condition set by the processing filter 132b is a processing condition to execute a function A which is the same as the processing condition set by the processing filter 132a, and the processing logic part 132bb executes the image processing based on this processing condition. Further, the processing logic part 132bb can perform image processing based on a condition to perform another function, if the processing condition of the processing filter 132b is to perform a function different from the function A.

Further, the processing logic part 132bb notifies the processing UI 132ba and the activity. logic part 134Ab of progress of the processing (S1034, S1035). The processing logic part 132bb outputs the processed image data to the document registration logic part 133bb (S1036).

The document registration logic part 133bb executes accumulation processing of the image data after receiving the image data (S1037). Next, the document registration logic part 133bb notifies the document registration UI 133ba and the activity logic part 134Ab of progress of the processing (S1038, S1039). The activity logic part 134Ab notifies the activity UI 134Aa of progress of processing (S1040).

In the image processing apparatus 100A of this embodiment, multiple outputs are achieved as described above, and the image processing apparatus 100A can establish a processing condition of image data (independently) for plural output filters 133 independently.

Thus, the image processing apparatus 100A of this embodiment can modify a process setting of image data for each output.

In the following, a processing setting of image data of each output of the image processing apparatus 100A of this embodiment is described.

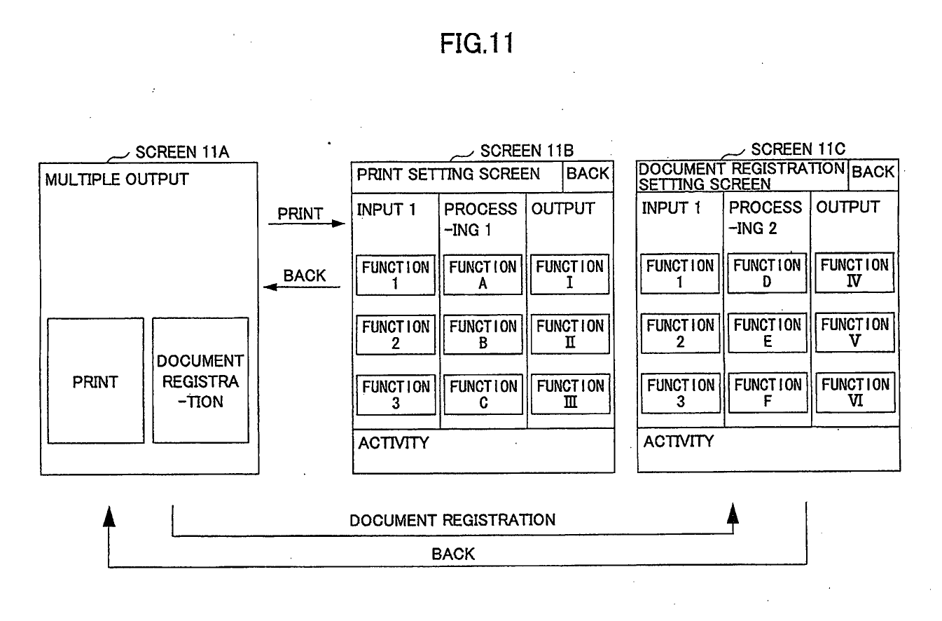

FIG. 11 is a drawing showing the first example of a setting screen in the image processing apparatus 100A of the second embodiment.

The image processing apparatus 100A of this embodiment displays a setting screen on an operation unit 18 as shown in FIG. 11.

For the image processing apparatus 10A, the operation unit 18 displays a screen 11A as shown in FIG. 11 when plural output filters 133 are chosen. In this case, the screen 11A shows that the print filter 133a and the document registration filter 133b are selected as the output filter 133. In the screen 11A, when an output filter having a condition to be established is chosen in screen 11A, the screen is advanced to a screen 11B or a screen 11C depending upon the setting condition of each output.

For example, the screen 11A changes to screen 11B when “print” is chosen in the screen 11A. The screen 11B is provided to establish each filter which is used until the image data is output by the print filter 133a. For example, in the screen 11B, a reading condition of the reading filter 131a which is the input filter 131, a processing condition in the processing filter 132a and a print condition in the print filter 133a can be established. In this case, a reading condition indicates a setting of resolution when reading a manuscript, for example; a processing condition is a setting condition such as the collection, color printing or the like; and a print condition is a setting condition such as the number of copies to print double-sided print or the like.

Further, for example, when “document registration” is chosen on the screen 11A, the screen 11A changes to the screen 11C. In the screen 11C, each filter which is used till the image data is output by the document registration filter 133b can be established. Further, in an example shown in FIG. 11, both the input filters 131 are reading filters 131a. In the screen 11C, settings can be established for a processing condition in the processing filter 132b connected to the document registration filter 133b and a document registration condition in the document registration filter 133b. Further, the document registration condition (for example) is a setting such as a file name of image data to be registered, a setting of registration destination or the like.

In this embodiment, when one of the output filters 133 is chosen on the screen 11A, the screen changes to a setting screen corresponding to the selected output filter 133, and returns to the screen 11A again after the setting is completed. Thus, when “print” is chosen in the screen 11A, the screen 11A changes to the screen 11B and returns to the screen 11A when the setting is completed in the screen 11B. Further when “document registration” is chosen on the screen 11A, the screen 11A changes to the screen 11C. When the setting is completed in the screen 11C, it returns to the screen 11A.

In this manner, the image processing apparatus 100A of this embodiment can output image data for each output process by an independent setting.

Also, in the image processing apparatus 100A of this embodiment, when an output filter 133 has been selected on the screen 11A, and when the setting corresponding to the selected output filter 133 is established, this setting may be established to correspond to other output filters 133.

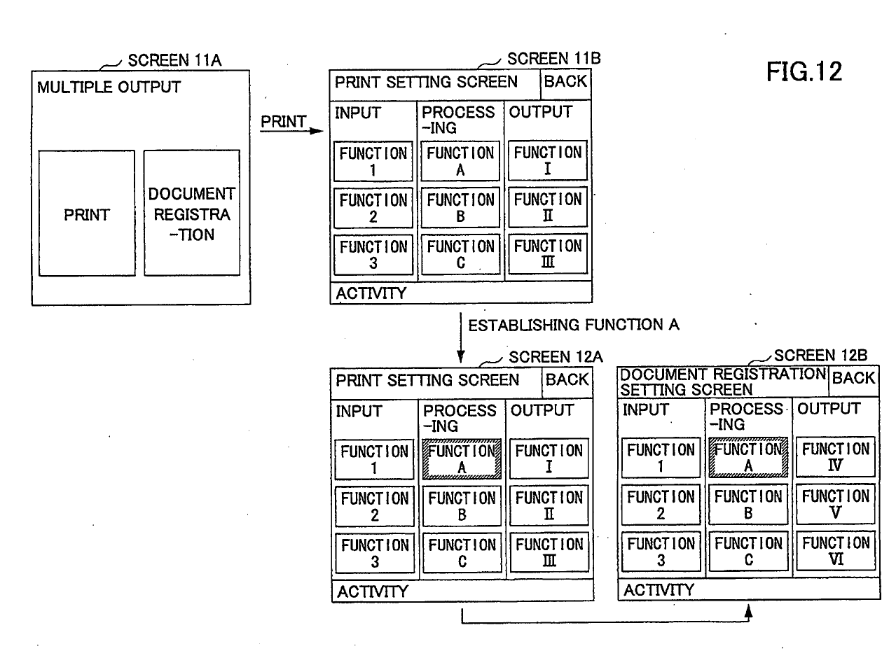

FIG. 12 is a drawing showing the second example of a setting screen in the image processing apparatus 100A of the second embodiment. When “print” is chosen in the screen 11A displayed by the operation unit 18, the setting screen changes from the screen 11A into screen 11B. When the function A is established as a processing condition in the screen 11B, the screen 11B changes to a screen 12A to show that the function A has been established.

The image processing apparatus 100A of this embodiment can establish function A which is established as being a processing condition corresponding to “print” in screen 11B as a processing condition corresponding to “document registration” as is. The screen 12B shows the state where the function A established in the screen 11B is established in a setting screen where the “document registration” is chosen.

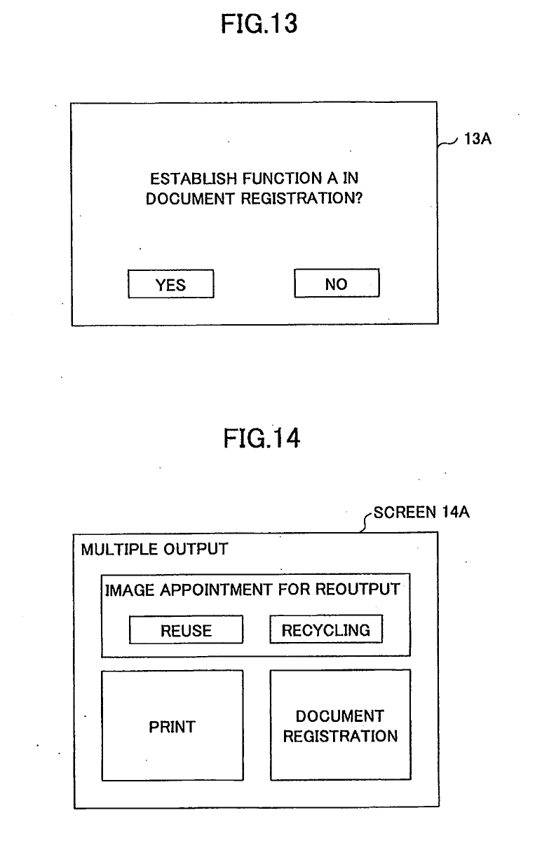

Further, in the image processing apparatus 100A of this embodiment, a setting screen displayed on the operation unit 18 may display a screen 13A shown in FIG. 13 after having changed the screen 11B into the screen 12A. FIG. 13 is a drawing showing the third example of a setting screen in the image processing apparatus 100A of the second embodiment. For the image processing apparatus 100A, after the function A is established by the screen 12A, a screen 13A is displayed for inquiring whether the function A should be established as a condition of document registration. When the function A is selected on the screen 13A, the function A is established in “document registration” and the screen changes from the screen 13A into the screen 12B.

In this embodiment, when the same setting is performed for plural outputs and when a setting condition is duplicated, it is not necessary for performing the setting operations for plural times by sharing the same setting, thus the image processing apparatus 100A can improve its operation.

Further, the image processing apparatus 100A of this embodiment may be capable of establishing a setting of accumulation of image data. Accumulation of image data is described in the following.

In this embodiment, image data can be accumulated by the document registration filter 133b. The image processing apparatus 100A of this embodiment may accumulate the image data read by the input filter 131 as unmodified, when the image data are accumulated by the document registration filter 133b. The unmodified image data can be established by a processing condition, a print condition or the like, when being read and output again.

Further, in the image processing apparatus 100A of this embodiment, the input filter 131 reads image data, and after having processed the image data by the processing filter 132, the processed image data may be accumulated. For the accumulated image data that has been processed, when the accumulated image data are output again, the image data can be re-output with the same setting which was determined at the time accumulation was performed.

In the following explanation, accumulating image data that has not been processed is defined as “unmodified”, and accumulating image data that has been processed is defined as “modified”. In addition, in this embodiment, image data may be accumulated in a secondary storage device 14, or may be accumulated in a storage device externally connected to the image processing apparatus 10A by an appropriate method.

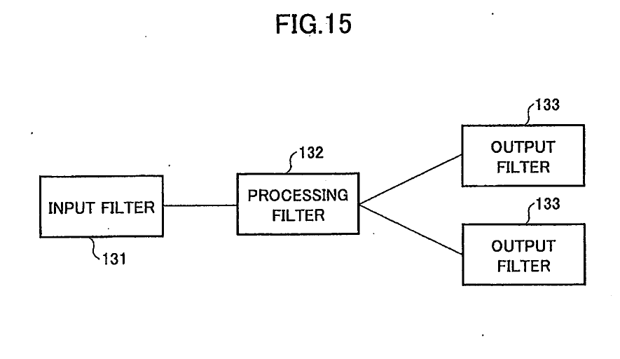

In the image processing apparatus 100A of this embodiment, when the document registration filter 133b is chosen as one of the output filters 133 for multiple outputs of image data, a screen shown in FIG. 14 may be displayed on an operation unit 18. FIG. 14 is a drawing showing the fourth example of a setting screen of the image processing apparatus 100A of the second embodiment.

In the image processing apparatus 100A, when the document registration filter 133b is chosen as the output filter 133, the operation unit 18 displays a screen 14A instead of screen 11A (see FIG. 11). For the screen 14A, it may be possible for image data to be accumulated as “unmodified” or “modified”. If “unmodified” is chosen in the screen 14A, the document registration filter 133b accumulates the image data as unprocessed; If “modified” is chosen in the screen 14A, the document registration filter 133b accumulates the image data as having been processed. When the selection about the accumulation of image data is completed, the screen 14A changes into the screen 11B. The processing after changing into the screen 11B is the same as being mentioned above.

Further, in the image processing apparatus 100A of this embodiment, plural output filters 133 are chosen and a case where all the processing conditions of the processing filters 132 to be connected with plural output filters 133 is the same, the plural output filters 133 may be connected to a single processing filter 132. Specifically, for example, when a single processing filter 132 is established to reflect on other processing filters 132 as described in FIG. 12, the plural output filters 133 may be connected to a single processing filter 132. FIG. 15 is a drawing showing a filter block diagram in which plural output filters 133 are connected to a single processing filter 132.

For the image processing apparatus 100A of this embodiment, when plural output filters 133 are chosen with a case where all the processing conditions of the processing filter 132 to be connected with plural output filters 133 is the same, the plural output filters 133 may be connected to a single processing filter 132. Specifically, for example, as described in FIG. 12, when a setting of a single processing filter 132 is established to reflect on other processing filters 132, plural output filters 133 may be connected to the single processing filter 132. FIG. 15 is a drawing showing a filter block diagram in which plural output filters 133 are connected to a single processing filter 132.

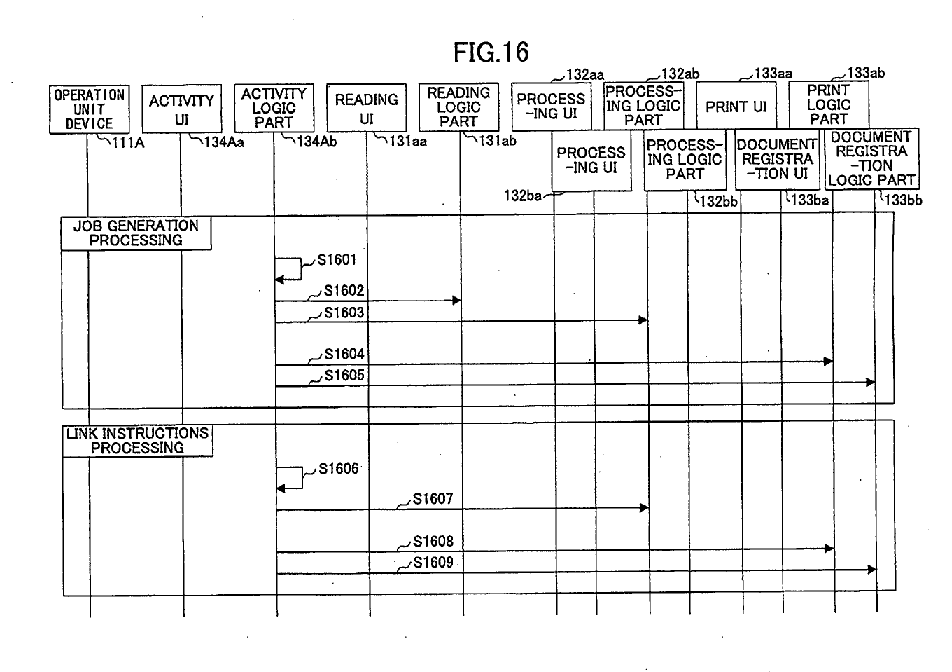

In the following, by referring to FIG. 16, the operation is described for which plural output filters 133 are connected to a single processing filter 132. FIG. 16 is a sequence diagram explaining the operation in which plural output filters are connected to a single processing filter in the image processing apparatus 100A of the second embodiment.

After receiving an execution instruction of processing from the operation unit 18, the activity logic part 134Ab determines a job to be executed by each filter (S1601) based on the requested execution instruction. The activity logic part 134Ab generates a job of the reading logic part 131ab (S1602). Also, the activity logic part 134Ab generates a job of the processing logic part 132ab (S1603). Further, the activity logic part 134Ab generates jobs of the print logic part 133ab and document registration logic part 133bb (S1604, S1605).

After jobs to be executed by respective filters are generated, the activity logic part 134Ab determines an association of each filter based on a job (S1606). The activity logic part 134Ab connects the processing filter 132b with the reading filter 131a (S1607). Further, the activity logic part 134Ab determines that conditions established in the processing filter 132b and the processing filter 132a are the same for the association of each filter, and connects the print filter 133a with the document registration filter 133b using the processing filter 132a (S1608, S1609).

In this manner, for this embodiment, even in a case of multiple outputs, if a processing condition established by each output is the same, it is possible for a processing filter 132a to output the processed image data to plural output filters 133. Therefore, image processing performed on image data may be one-time image processing by the processing filter 132a, which thus saves memory capacity and improves productivity.

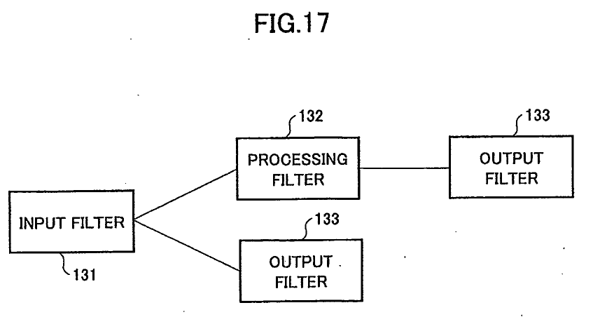

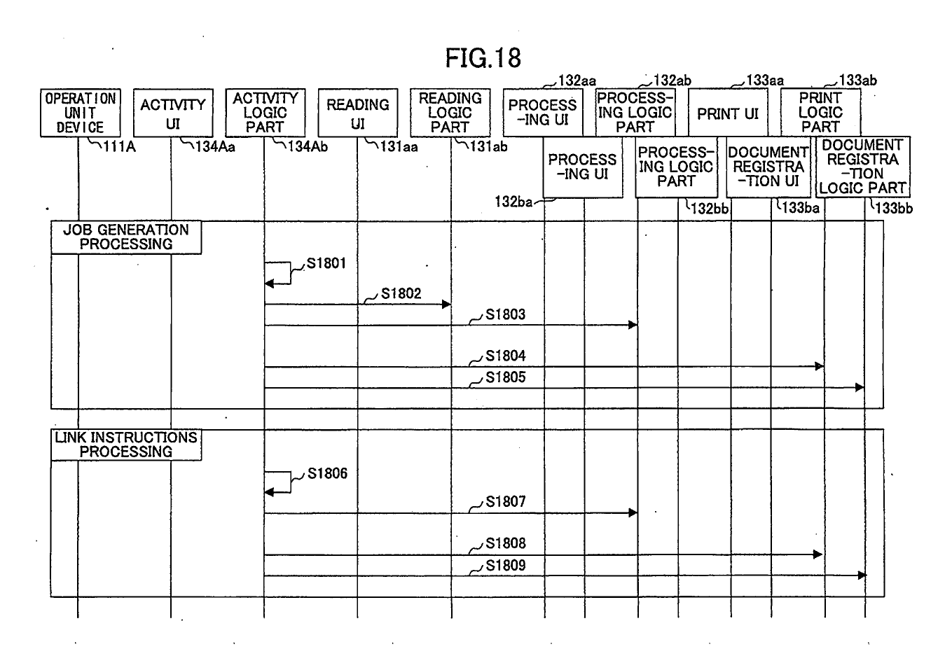

Further, in the image processing apparatus 100A of this embodiment, when the output filter 133 outputs unprocessed image data, the output filter 133 may be connected to the input filter 131 directly. FIG. 17 is a drawing showing a filter block diagram where the output filter 133 is connected to the input filter 131 directly. In the following, referring to FIG. 18, the operation is described how the output filter 133 is directly connected with the input filter 131. Further, FIG. 18 shows the operation in which the document registration filter 133b is connected to the reading filter 131a. FIG. 18 is the sequence diagram explaining the operation that the document registration filter 133b is connected (explanation) to the reading filter 131a in the image processing apparatus 100A of the second embodiment.

In FIG. 18, since processing from S1801 to S1805 are similar to those of the processes from S1601 to S1605 of FIG. 16, the explanation of those processing will be omitted.

When a job to be executed by each filter is generated, the activity logic part 134Ab determines an association of each filter based on the job (S1806). Further, the activity logic part 134Ab connects the processing filter 132b with the reading filter 131a (S1807). The activity logic part 134Ab also connects the print filter 133a with processing filter 132a (S1808). Next, the activity logic part 134Ab determines a setting to accumulate unprocessed image data of the document registration filter 133b in association with each filter, and connects the document registration filter 133b with the reading filter 131a (S1809).

In FIG. 18, a description is made for a case where image data is accumulated as unprocessed by the document registration filter 133b. However, this embodiment is not limited to this case. In this embodiment, as long as the operation outputs image data as unmodified, the output filter 133 directly connected to the reading filter 131a may be an output filter other than the document registration filter 133b.

In this manner, for this embodiment, when image data is output as unprocessed, the input filter 131 is connected to the output filter 133 directly. Thus, image processing by the processing filter 132 can be removed and saving memory capacity and improving productivity become possible.

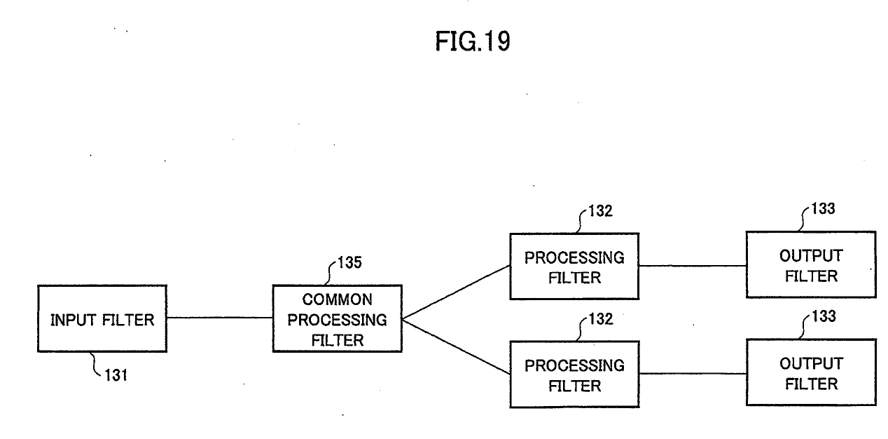

Also, in the image processing apparatus 100A of this embodiment, when a condition respectively established in each output includes a common part, a common processing filter 135 may be connected between the input filter 131 and the processing filter 132 to perform image processing based on the common condition. FIG. 19 is a drawing showing a filter image in which a common processing filter 135 is connected between the input filter 131 and the processing filter 132.

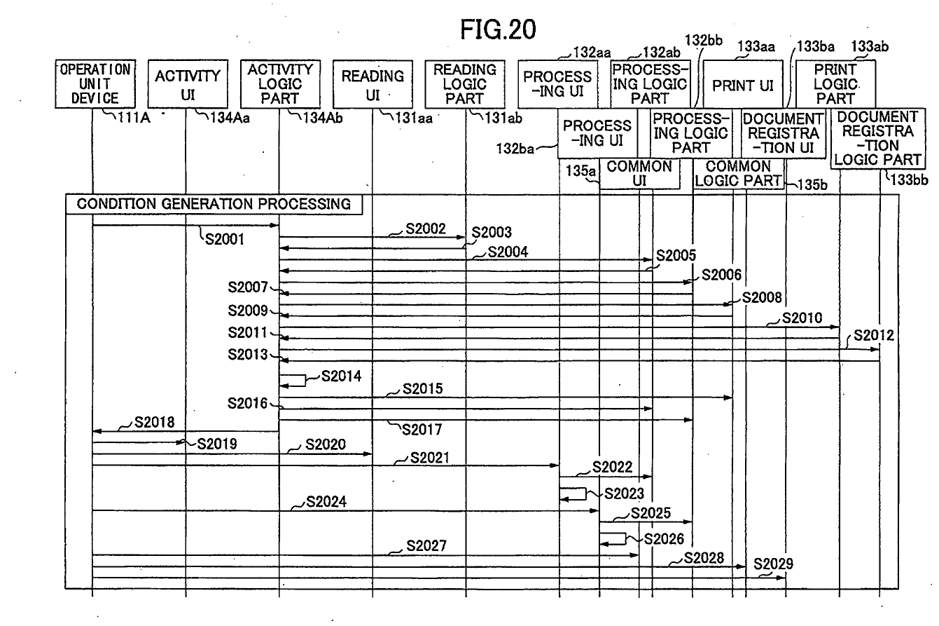

Referring to FIG. 20 in the following, an operation is described in which a common processing filter 135 is connected between the input filter 131 and the processing filter 132. FIG. 20 is a sequence drawing describing the operation where a common processing filter 135 is connected between the input filter 131 and the processing filter 132. In FIG. 20, a description is given for a case where a common processing filter 135 is connected between the reading filter 131a included in the input filter 131 and processing filters 132a, 132b.

In the image processing apparatus 100A, when a setting instruction is performed in the operation unit 18, the operation unit device 111A notifies the activity logic region 134Ab of receiving the instruction (S2001). The activity logic part 134Ab transmits a setting instruction of a reading condition to the reading logic part 131ab (S2002). After receiving the setting instruction, the reading logic part 131ab executes a predetermined default setting, and transmits that the setting has been established to the activity logic part 134Ab (S2003).

Further, the activity logic part 134Ab transmits a setting instruction of a processing condition to the processing logic part 132ab (S2004). After receiving the setting instruction, the processing logic part 132ab establishes a predetermined default setting, and transmits that the setting has been established to the activity logic part 134Ab (S2005). The activity logic part 134Ab transmits a setting instruction of a reading condition to the processing logic part 132bb (S2006). After receiving the setting instruction, the processing logic part 132bb establishes a predetermined default setting, and transmits that the setting is established to the activity logic part 134Ab (S2007).

The activity logic part 134Ab transmits a setting instruction of a processing condition to a common processing logic part 135b that is a logic part of the common processing filter 135 (S2008). After receiving the instruction of the processing condition, the common processing logic part 135b establishes a predetermined default setting, and transmits that the setting is established to the activity logic region 134Ab (S2009).

The activity logic part 134Ab transmits a setting instruction of a print condition to the print logic part 133ab (S2010). After receiving the setting instruction of the print condition, the print logic part 133ab establishes a predetermined default setting, and transmits that the setting has been established to the activity logic region 134Ab (S2011). The activity logic part 134Ab transmits a setting instruction of a document registration condition to the document registration logic part 133bb (S2012). After receiving the setting instruction, the document registration logic part 133bb establishes a predetermined default setting, and transmits that the setting has been established to the activity logic part 134Ab (S2013).

Next, the activity logic part 134Ab determines a setting condition-to be set as a common processing condition of the common processing filter 135 (82014). Specifically, the activity logic part 134Ab determines whether a common condition is included in the processing conditions established by the processing filter 132a and the processing filter 132b. If a condition in common is included, the activity logic part 134Ab establishes the condition in common as the processing condition of the common processing filter 135.

The activity logic part 134Ab establishes the setting condition of the common processing condition for the common processing logic part 135b (S2015). For example, here, the function A is assumed as the common processing condition.

Next, the activity logic part 134Ab makes the common processing condition among the processing conditions of the processing filter 132a (S2016) unavailable. Similarly for the processing filter 132b, the activity logic part 134Ab makes the common processing condition among the processing conditions of the processing filter 132b (S2017) invalid. Thus, processing conditions of the processing filters 132a and 132b become processing conditions that execute functions other than the function A. After the setting of a processing condition is completed, the activity logic part 134Ab notifies the operation unit device 111A of the completion of the setting (S2018).

The operation unit device 111A receives this notice and transmits instruction to display a setting screen to the activity UI 134Aa (S2019). Also, the operation unit device 111A transmits an instruction to display a screen to the reading UI 131aa and the processing UI 132aa (S2020, S2021).

After receiving the instruction to display the setting screen, the processing UI 132aa determines in the processing logic part 132ab whether there is a processing condition that is made as being unavailable (invalid) in common processing conditions (condition to perform the function A) in S2015 (S2022). When there is a processing condition treated as being invalid in S2022, the processing UI 132aa determines the common processing condition as being invalid in a screen as well (S2023).

The operation unit device 111A transmits an instruction to display a setting screen to the processing UI 132ba (S2034). After receiving the instruction to display a setting screen, the processing UI 132ba finds in processing logic part 132bb whether there is a processing condition which is invalidated as a common processing condition (a condition to perform function A) in S2015 (S2025). When there is such a processing condition treated as being invalid in S2025, the processing UI 132ba invalidates the common processing condition for the screen (S2026).

Further, the operation unit device 111A transmits an instruction to display a setting screen to the common processing UI 135a, the print UI 133aa and the document registration UI 133ba, respectively (S2027, S2028, S2029).

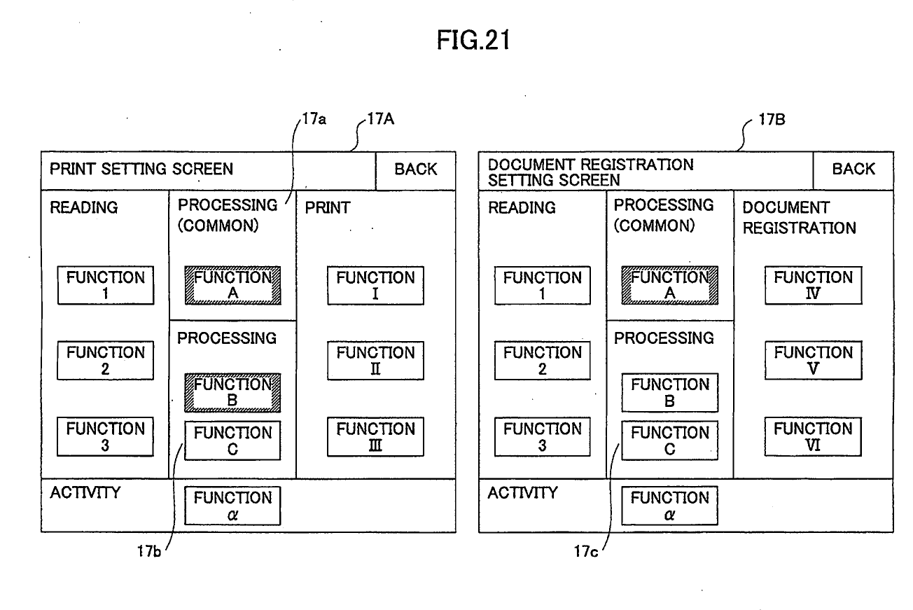

In the image processing apparatus 100A of this embodiment, the display of a setting screen is performed as described above. FIG. 21 shows an example of a setting screen displayed by the processing that is explained in FIG. 20. FIG. 21 is a drawing showing the fifth example of a setting screen in the image processing apparatus 100A of the second embodiment.

For the image processing apparatus 100A of this embodiment, the screen 17A and screen 17B are displayed on the operation unit 18 as a setting screen for a case where the common processing filter 135 is connected to the end of the reading filter 131a. The screen 17A is one example of a setting screen for a case where “print” is chosen as the output, and the screen 17B is an example of a setting screen for the case where “document registration” is chosen as the output.

In this embodiment, as a requirement to perform the function A is a common processing condition. In this case, the function A is established on the setting columns of the common processing filter 135 in the screen 17A (column 17a) and screen 17B (see FIG. 21). Further, the function A is neither displayed in a setting column 17b of the processing filter 132a of screen 17A nor in a setting column 17c of the processing filter 132b of the screen 17B. Thus, it is found that a common processing condition is not included in the processing filters 132a, 132b.

In this manner, for this embodiment, the image processing based on a common processing setting is performed by a single processing filter, and only processing conditions different between respective outputs are performed by the individual processing filters. Therefore, in this embodiment, a repetition of image processing based on the same processing condition may be avoided, and saving memory capacity and improvement of productivity become feasible.

Further, in the image processing apparatus 100A of this embodiment, the activity logic region 134Ab determines the architecture of the filters shown in FIG. 15, FIG. 17 and FIG. 19 based on an execution request for processing. Thus, the activity 134A of this embodiment includes a filter architecture determining function to determine the architecture of connections of the input filter 131, the processing filter 132, and the output filter 133. In the following, determination of the filter architecture by the activity logic part 134Ab is explained.

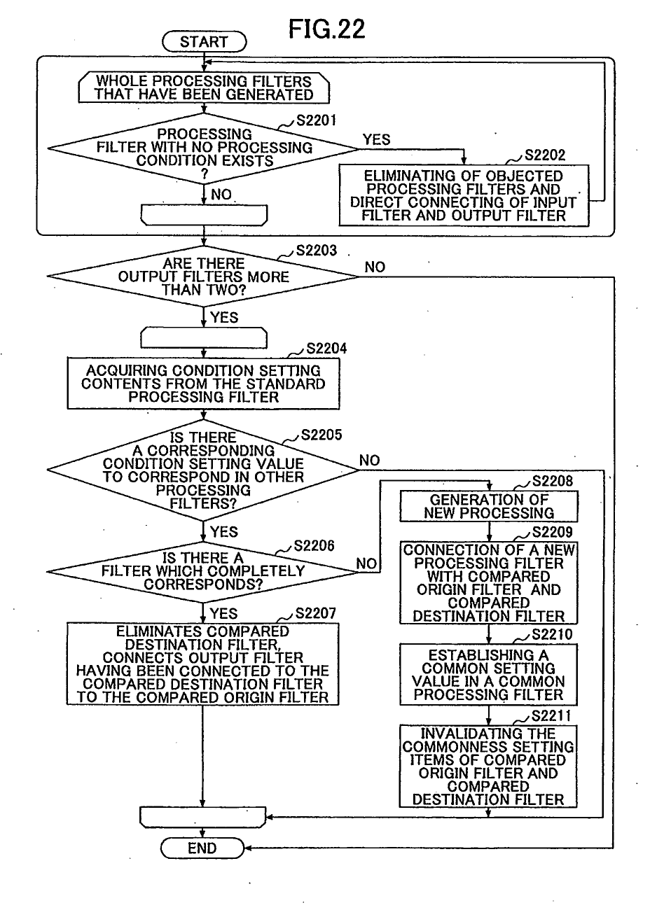

FIG. 22 is a flowchart describing determination of the filter architecture in the image processing apparatus 100A of the second embodiment. In this embodiment, the activity logic part 134Ab (as filter architecture determining unit) determines the filter architecture when a job to be executed by each filter is generated based on an execution request for processing (S925 of FIG. 9).

After a job to be executed by each filter is generated, the activity logic part 134Ab determines whether processing filters 132, whose process conditions are not established, exist in the whole processing filters 132 (S2201). When the processing filters 132, whose process conditions are not established, does exist in S2201, the activity logic part 134Ab eliminates the processing filters 132 whose process conditions are not established and determines to directly connect the output filter 133 with the input filter 131 as the filter architecture (S2202). FIG. 17 shows a block diagram of the filter architecture determined in S2202.

Next, the activity logic part 134Ab determines whether there are plural output filters 133 (S2203). When plural output filters 133 exist in S2203, the activity logic part 134Ab determines a standard processing filter 132 from processing filters 132, and acquires a processing condition from this standard processing filter 132 (S2204).

Next, the activity logic part 134Ab compares between the processing condition (standard process condition) of the standard processing filter 132 and processing conditions established by other processing filters 132, and determines whether there are identical processing conditions to the standard process condition (S2205). When there is a processing condition corresponding to the standard process condition in S2205, the activity logic part 134Ab determines whether there is a processing filter 132 whose processing condition entirely corresponds to the standard processing condition (S2206).

When there is a processing filter 132 having a processing condition that completely corresponds to the standard processing condition in S2206, the activity logic part 134Ab eliminates this processing filter 132 and determines to connect the output filter 133 with the standard processing filter 132 as the filter architecture (S2207). FIG. 15 shows an image of the filter architecture determined in S2207.

In S2206, when there is no processing filter 132 that includes a processing condition which completely corresponds to the standard processing condition, the activity logic part 134Ab generates a new processing filter (S2208). A processing filter generated in S2208 is a common processing filter 135. The activity logic part 134Ab determines to connect the generated common processing filter 135 with the processing filter 132 having been generated already as a filter architecture (S2209). FIG. 19 shows a block diagram of filter architecture determined in S2209.

Next, the activity logic part 134Ab establishes a setting condition which is in common in the processing filters 132 for the common processing filter 135 (S2210). Further, the activity logic part 134Ab invalidates the common processing condition included in the processing condition established by the processing filter 132 (S2211).

In this manner, for the image processing apparatus 100A of this embodiment, the filter architecture is determined from a job generated based on execution instruction for requested processing. Thus, according to this embodiment, an appropriate filter architecture can be determined for execution of a job, and it becomes possible for each processing condition to maintain a degree of freedom for setting processing conditions and optimizing image processing. As a result, an increase in efficiency of memory and improvement of productivity can be achieved.

The present invention is not limited to the specifically disclosed embodiments, and variations and modifications may be made without departing from the scope of the present invention.

The present application is based on Japanese priority application No. 2007-270021 filed on Oct. 17, 2007, the entire contents of which are hereby incorporated herein by reference.

What is claimed is:

1. An image processing apparatus, comprising:
an input filter configured to control an input process of image data input as an object being processed;
output filters configured to control output processes of output image data being output to an outside of the apparatus;
at least one process filter configured to process the image data between the input filter and the output filter; and
an operation unit configured to manage process operation of the image processing apparatus;
wherein when the plural output filters are selected by the operation unit for the input filter selected by the operation unit, the at least one process filter is connected to each of the selected output filters.

2. The image processing apparatus as claimed in claim 1, wherein a setting condition of the at least one process filter connected to one of the selected plural output filters is reflected on setting conditions of the other process filters connected to the rest of the selected output filters.

3. The image processing apparatus as claimed in claim 1, wherein a part of a setting condition of one of the at least one process filter connected to one of the selected plural output filters is reflected on setting conditions of the other process filters connected to the rest of the selected output filters.

4. The image processing apparatus as claimed in claim 1, wherein a part of a setting condition or a setting condition of the at least one process filter connected to one of the selected plural output filters is reflected on setting conditions of the other process filters connected to the rest of the selected output filters.

5. The image processing apparatus as claimed in claim 1, wherein when setting conditions of the at least one process filter connected to each of the selected output filters are identical, the selected plural output filters are connected to one of the at least one process filter connected to each of the selected output filters.

6. The image processing apparatus as claimed in claim 1, wherein when the at least one process filter connected to each of the selected plural output filters include process filters having a setting condition established so as not to process the image data, the selected output filters connected to the at least one process filter having the setting condition established so as not to process the image data are connected to the input filters.

7. The image processing apparatus as claimed in claim 1, wherein when the at least one process filter connected to each of the selected plural output filters include common setting conditions, the at least one process filter having the common setting conditions are connected between the input filter and the at least one process filter connected to each of the selected output filters.

8. The image processing apparatus as claimed in claim 1, further comprising a filter architecture determining unit which determines an architecture of filter connections of the input filter, the at least one process filter and the output filter.

9. An image processing method comprising the steps of:
(a) controlling an input process of image data input as an object being processed;
(b) controlling output processes of output image data being output to an outside of the apparatus;
(c) processing the image data, at least one time, between step (a) and step (b); and
(d) providing a managing process operation of an image processing apparatus;
wherein when the managing step (d) selects the step (a) and the step (b), and plural steps (b) are selected to correspond to one of the steps (a) selected by step (d), the at least one of steps (c) precedes each of the selected plural steps (b).

10. A computer-readable recording medium having instructions executable by a computer to execute an image processing method comprising the steps of:
(a) controlling an input process of image data input as an object being processed;
(b) controlling output processes of output image data being output to an outside of the apparatus;
(c) processing the image data, at least one time, between step (a) and step (b); and
(d) providing a managing process operation of an image processing apparatus;
wherein when the managing step (d) selects the step (a) and the step (b), and plural steps (b) are selected to correspond to one of the steps (a) selected by step (d), the at least one of steps (c) precedes each of the selected plural steps (b).
